(19) United States
(12) Patent Application Publication
(10) Pub. No.: US 2022/0410732 A1
(43) Pub. Date: Dec. 29, 2022

(54) VEHICLE, METHOD OF CONTROL OF POWER RECEPTION OF VEHICLE, AND NONTRANSITORY COMPUTER RECORDING MEDIUM

(71) Applicant: TOYOTA JIDOSHA KABUSHIKI KAISHA, Aichi-ken (JP)

(72) Inventors: Daiki YOKOYAMA, Gotemba-shi (JP); Toshiya HASHIMOTO, Miyoshi-shi (JP); Hiroya CHIBA, Susono-shi (JP); Shuntaro OKAZAKI, Sunto-gun (JP); Shogo TSUGE, Fuji-shi (JP); Kazuhisa MATSUDA, Sunto-gun (JP)

(21) Appl. No.: 17/844,722

(22) Filed: Jun. 21, 2022

(30) Foreign Application Priority Data
Jun. 23, 2021 (JP) 2021-104200

(51) Int. Cl. B60L 53/122; H02J 50/10; H02J 50/80

(52) U.S. Cl. CPC B60L 53/122; H02J 50/10; H02J 50/80

(57) ABSTRACT

A vehicle configured to be able to suitably judge whether to be supplied with power by noncontact while running, that is, a vehicle configured to receive power from a ground power supplying apparatus by noncontact, comprising a control device for controlling reception of power from the ground power supplying apparatus while running based on charging scheduled after the vehicle finishes running.

### FIELD

The present disclosure relates to a vehicle, a method of control of power reception of a vehicle, and a nontransitory computer recording medium.

### BACKGROUND

Known in the past has been a noncontact power supplying system using transfer systems such as magnetic field coupling (electromagnetic induction), electric field coupling, magnetic field resonance coupling (magnetic field resonance), and electric field resonance coupling (electric field resonance) to transfer power from a ground power supplying apparatus provided in the ground surface to a running vehicle. Japanese Unexamined Patent Publication No. 2018-157686 discloses a conventional noncontact power supplying system configured so that when a power supply request is sent from a running vehicle to a ground power supplying apparatus, the ground power supplying apparatus receiving that power supply request supplies power to the running vehicle by noncontact.

### SUMMARY

If comparing a case of supplying power to a running vehicle by noncontact with a case of supplying power to a vehicle in a state parked and stopped after finishing running by contact by a cable or supplying power to it by noncontact wirelessly, the power loss tends to become greater in the former case. For this reason, if comparing the electricity bill if receiving power by noncontact power supply while running and the electricity bill if receiving power by contact power supply or noncontact power supply while stopped, even if the received amounts of power were the same, the electricity bill would be liable to become higher in the former case.

However, at the present time, it is not possible to judge whether to supply power by noncontact while running based on this viewpoint, so power is liable to end up being supplied by noncontact while running where the power loss becomes greater regardless of power being able to be supplied by contact or power being able to be supplied by noncontact to a vehicle in a state parked after finishing running.

The present disclosure was made focusing on such a problem and has as its object to enable suitable judgment of whether to supply power by noncontact while running.

To solve this problem, the vehicle according to one aspect of the present disclosure is a vehicle configured to receive power from a ground power supplying apparatus by noncontact, comprising a control device provided with a processor configured to control reception of power from the ground power supplying apparatus while running based on charging scheduled after the vehicle finishes running.

Further, the method of control of reception of power of a vehicle receiving power from a ground power supplying apparatus by noncontact according to another aspect of the present disclosure is a method of control of reception of power of a vehicle receiving power from a ground power supplying apparatus by noncontact, comprising controlling the reception of power from the ground power supplying apparatus while running based on charging scheduled after the vehicle finishes running.

Further, according to another aspect of the present disclosure, there is provided a program for making a processor of a control device of a vehicle receiving power from a ground power supplying apparatus by noncontact control the reception of power from the ground power supplying apparatus while running based on charging scheduled after the vehicle finishes running and a nontransitory computer recording medium including the same.

According to these aspects of the present disclosure, it is possible to suitably judge whether to supply power by noncontact while a vehicle is running considering the charging scheduled after finishing running. As a result, it is possible to keep power from ending up being received by noncontact power supply while running where the power loss becomes greater regardless of power being able to be supplied by contact or power being able to be supplied by noncontact to a vehicle in a state parked and stopped after finishing running.

### BRIEF DESCRIPTION OF DRAWINGS

FIG. 1 is a view schematically showing the configuration of a noncontact power supplying system.

FIG. 2 is a schematic view of the configuration of a controller and equipment connected to the controller.

FIG. 3 is a schematic view of the configuration of an ECU and equipment connected to the ECU.

FIG. 4 is a schematic view of the configuration of a communication system used in a noncontact power supply system.

FIG. 5 is a view schematically showing a hardware configuration of a server.

FIG. 6 is a flow chart for explaining one example of processing according to one embodiment of the present disclosure performed in the ECU.

FIG. 7 is a flow chart for explaining one example of processing according to a modification of the present disclosure performed in the ECU.

### DESCRIPTION OF EMBODIMENTS

Below, referring to the drawings, embodiments will be explained in detail. Note that, in the following explanation, similar elements will be assigned the same reference notations.

Overall Configuration of Noncontact Power Supplying System

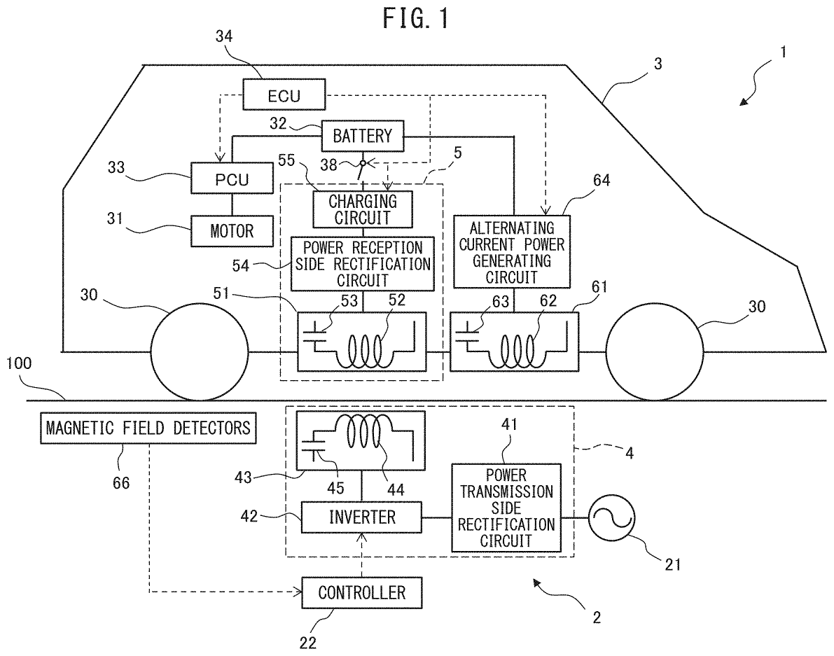

FIG. 1 is a view schematically showing the configuration of a noncontact power supplying system 1. The noncontact power supplying system 1 has a ground power supplying apparatus 2 and a vehicle 3 running on a road 100, and transfers power by noncontact from the ground power supplying apparatus 2 to the vehicle 3 by magnetic field resonant coupling (magnetic field resonance). In particular, in the present embodiment, the noncontact power supplying system 1 transfers power by noncontact from the ground power supplying apparatus 2 to the vehicle 3 while the vehicle 3 is running. Therefore, the ground power supplying apparatus 2 transmits power to the vehicle 3 by noncontact while the vehicle 3 is running, and the vehicle 3 receives power from the ground power supplying apparatus 2 by noncontact while the vehicle 3 is running. The ground power supplying apparatus 2 has a power transmission apparatus 4 configured to transmit power by noncontact, while the vehicle 3 has a power reception apparatus 5 configured to receive power from the power transmission apparatus 4 by noncontact. As shown in FIG. 1, the power transmission apparatus 4 is buried in the road 100 (in the ground), for example, at the center of the lane on which the vehicle 3 runs.

Note that, the term “while (a vehicle is) running” or “running vehicle” means the state where the vehicle 3 is positioned on the road for running. Therefore, the term “while (a vehicle is) running” or “running vehicle” includes not only the state where the vehicle 3 is actually running at any speed greater than zero, but also, for example, the state where it is stopped on the road while, for example, waiting for a traffic light to change. On the other hand, even if the vehicle 3 is positioned on a road, if, for example, it is parked, this is not included in “while (a vehicle is) running” or “running vehicle”

Configuration of Ground Power Supplying Apparatus

As shown in FIG. 1, the ground power supplying apparatus 2 is provided with a power source 21 and a controller 22, in addition to the power transmission apparatus 4. The power source 21 and the controller 22 may be buried inside the road 100, and may be arranged at a location (including ground) separate from the inside of the road 100.

The power source 21 supplies power to the power transmission apparatus 4. The power source 21, for example, is a commercial alternating current power supply for supplying single-phase alternating current power. Note that, the power source 21 may be another type of an alternating current power supply for supplying three-phase alternating current power, or may be a direct current power supply such as a fuel cell.

The power transmission apparatus 4 transmits the power supplied from the power source 21 to the vehicle 3. The power transmission apparatus 4 has a power transmission side rectification circuit 41, inverter 42, and power transmission side resonance circuit 43. In the power transmission apparatus 4, the alternating current power supplied from the power source 21 is rectified and converted to direct current power at the power transmission side rectification circuit 41, this direct current power is converted to alternating current power at the inverter 42, and this alternating current power is supplied to the power transmission side resonance circuit 43.

The power transmission side rectification circuit 41 is electrically connected to the power source 21 and inverter 42. The power transmission side rectification circuit 41 rectifies the alternating current power supplied from the power source 21 to convert it to direct current power, and supplies the direct current power to the inverter 42. The power transmission side rectification circuit 41 is, for example, an AC/DC converter.

The inverter 42 is electrically connected to the power transmission side rectification circuit 41 and power transmission side resonance circuit 43. The inverter 42 converts the direct current power supplied from the power transmission side rectification circuit 41 to an alternating current power of a frequency higher than the alternating current power of the power source 21 (high frequency power), and supplies the high frequency power to the power transmission side resonance circuit 43.

The power transmission side resonance circuit 43 has a resonator comprised of a coil 44 and capacitor 45. The various parameters of the coil 44 and capacitor 45 (outside diameter and inside diameter of the coil 44, the number of turns of the coil 44, electrostatic capacity of the capacitor 45) are determined so that the resonance frequency of the power transmission side resonance circuit 43 becomes a predetermined set value. The predetermined set value is, for example, 10 kHz to 100 GHz, preferably is the 85 kHz determined by the SAE TIR J2954 standard as the frequency band for noncontact power transfer.

The power transmission side resonance circuit 43 is arranged at the center of the lane on which the vehicle 3 runs so that the center of the coil 44 is positioned at the center of the lane. If the high frequency power supplied from the inverter 42 is applied to the power transmission side resonance circuit 43, the power transmission side resonance circuit 43 generates an alternating magnetic field for power transmission. Note that, if the power source 21 is a direct current power supply, the power transmission side rectification circuit 41 may be omitted.

The controller 22 is, for example, a general-purpose computer, and performs various control operations of the ground power supplying apparatus 2. For example, the controller 22 is electrically connected to the inverter 42 of the power transmission apparatus 4, and controls the inverter 42 so as to control power transmission by the power transmission apparatus 4. Furthermore, the controller 22 controls a later explained ground side first communication device 81 and ground side second communication device 82.

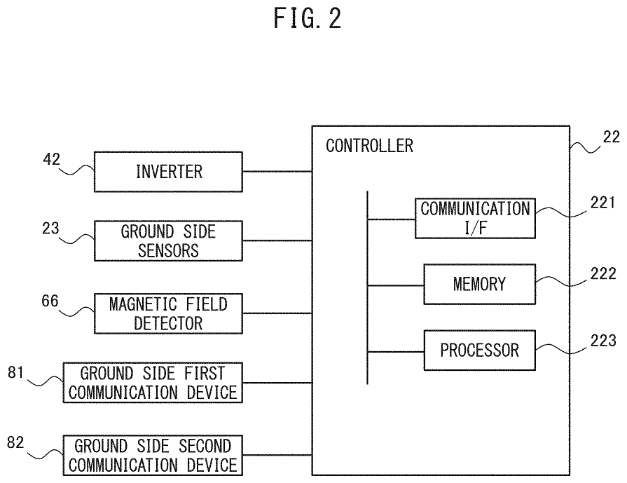

FIG. 2 is a schematic view of the configuration of the controller 22 and equipment connected to the controller 22. The controller 22 is provided with a communication interface 221, memory 222, and processor 223. The communication interface 221, memory 222, and processor 223 are connected to each other through signal wires.

The communication interface 221 has an interface circuit for connecting the controller 22 to various equipment forming the ground power supplying apparatus 2 (for example, the inverter 42, the later explained ground side sensors 23, ground side first communication device 81, and ground side second communication device 82) The controller 22 communicates with other equipment through the communication interface 221.

The memory 222, for example, has a volatile semiconductor memory (for example, RAM), nonvolatile semiconductor memory (for example, ROM), or equivalents. The memory 222 stores, for example, a computer program for performing various processing at the processor 223, and various data used when various processing is performed by the processor 223. The memory 222, for example, stores a list of vehicle identification information of vehicles which can be supplied with power by the ground power supplying apparatus 2 (below, referred to as the “identification information list”), and vehicle identification information of the vehicle 3 currently being supplied with power.

The processor 223 has one or more CPUs (central processing units) and their peripheral circuits. The processor 223 may further have a processing circuit such as a logic unit or arithmetic unit. The processor 223 performs various processing based on the computer program stored in the memory 222.

Further, as shown in FIG. 2, the ground power supplying apparatus 2 is further provided with ground side sensors 23. The ground side sensors 23 detect states of the ground power supplying apparatus 2. In the present embodiment, the ground side sensors 23, for example, include a power transmission apparatus current sensor for detecting the current flowing to various equipment of the power transmission apparatus 4 (in particular, the power transmission side resonance circuit 43, inverter 42, and power transmission side rectification circuit 41), a power transmission apparatus voltage sensor for detecting the voltage applied to various equipment of the power transmission apparatus 4, a power transmission apparatus temperature sensor for detecting a temperature of various equipment of the power transmission apparatus 4, a foreign object sensor for detecting a foreign object on the road in which the power transmission apparatus 4 is buried, and a living object sensor for detecting a living object on the road in which the power transmission apparatus 4 is buried. The outputs of the ground side sensors 23 are input to the controller 22.

Note that, the power transmission apparatus 4 may also be configured so as to enable power to be received from the vehicle 3. In this case, the power transmission apparatus 4 has a device or circuit for supplying the received power to the power source 21, similarly to the later explained power reception apparatus 5 of the vehicle 3. Further, in this case, the power transmission apparatus 4 may utilize a resonator comprised the above coil 44 and capacitor 45, in order to receive power from the vehicle 3.

Constitution of Vehicle

On the other hand, the vehicle 3, as shown in FIG. 1, has, in addition to the power reception apparatus 5, a motor 31, battery 32, power control unit (PCU) 33, and electronic control unit (ECU) 34. In the present embodiment, the vehicle 3 is an electric vehicle (BEV: Battery Electric Vehicle) having only the battery 32 as a power source. However, the vehicle 3 may also be a hybrid vehicle (HEV: Hybrid Electric Vehicle or PHEV: Plug-in Hybrid Electric Vehicle) provided with an engine or other source of power in addition to the battery 32.

The motor 31 is, for example, an alternating current synchronous motor, and functions as an electric motor and a generator. The motor 31 is driven using the power stored in the battery 32 as a source of power, when functioning as an electric motor. The output of the motor 31 is transmitted through a decelerator and shaft to the wheels 30. On the other hand, at the time of deceleration of the vehicle 3, the motor 31 is driven by rotation of the wheels 30, and the motor 31 functions as a generator to generate regenerated power.

The battery 32 is a rechargeable secondary battery, and is, for example, comprised of a lithium ion battery, nickel-hydrogen battery, or the like. The battery 32 stores the power required for running the vehicle (for example, the drive power of the motor 31). If the power which the power reception apparatus 5 receives from the power transmission apparatus 4 is supplied to the battery 32, the battery 32 is charged. Further, if the regenerated power generated by the motor 31 is supplied to the battery 32, the battery 32 is charged. If the battery 32 is charged, the state of charge (SOC) of the battery 32 is restored. Note that, the battery 32 may also be recharged through a charging port provided at the vehicle 3 by an outside power source other than the ground power supplying apparatus 2.

The PCU 33 is electrically connected to the battery 32 and motor 31. The PCU 33 has an inverter, booster converter, and DC/DC converter. The inverter converts the direct current power supplied from the battery 32 to alternating current power, and supplies the alternating current power to the motor 31. On the other hand, the inverter converts the alternating current power generated by the motor 31 (regenerated power) to direct current power, and supplies the direct current power to the battery 32. The booster converter boosts the voltage of the battery 32 in accordance with need, when the power stored in the battery 32 is supplied to the motor 31. The DC/DC converter lowers the voltage of the battery 32 when the power stored in the battery 32 is supplied to the headlights or other electronic equipment.

The power reception apparatus 5 receives power from the power transmission apparatus 4, and supplies the received power to the battery 32. The power reception apparatus 5 has a power reception side resonance circuit 51, power reception side rectification circuit 54, and charging circuit 55.

The power reception side resonance circuit 51 is arranged at a floor part of the vehicle 3 so that the distance from the road surface is small. In the present embodiment, the power reception side resonance circuit 51 is arranged at the center of the vehicle 3 in the vehicle width direction. The power reception side resonance circuit 51 has a configuration similar to the power transmission side resonance circuit 43, and has a resonator comprised of a coil 52 and capacitor 53. The various parameters of the coil 52 and capacitor 53 (outside diameter and inside diameter of the coil 52, the number of turns of the coil 52, electrostatic capacity of the capacitor 53, etc.) are determined so that the resonance frequency of the power reception side resonance circuit 51 conforms to the resonance frequency of the power transmission side resonance circuit 43. Note that, if the amount of deviation of the resonance frequency of the power reception side resonance circuit 51 and the resonance frequency of the power transmission side resonance circuit 43 is small, for example, the resonance frequency of the power reception side resonance circuit 51 is within a range of ±20% of the resonance frequency of the power transmission side resonance circuit 43, the resonance frequency of the power reception side resonance circuit 51 does not necessarily have to conform to the resonance frequency of the power transmission side resonance circuit 43.

As shown in FIG. 1, when the power reception side resonance circuit 51 faces the power transmission side resonance circuit 43, if an alternating magnetic field is generated by the power transmission side resonance circuit 43, vibration of the alternating magnetic field is transmitted to the power reception side resonance circuit 51 which resonates by the same resonance frequency as the power transmission side resonance circuit 43. As a result, an induction current flows in the power reception side resonance circuit 51 due to electromagnetic induction, and an induced electromotive force is generated at the power reception side resonance circuit 51 by the induction current. That is, the power transmission side resonance circuit 43 transmits power to the power reception side resonance circuit 51, and the power reception side resonance circuit 51 receives power from the power transmission side resonance circuit 43.

The power reception side rectification circuit 54 is electrically connected to the power reception side resonance circuit 51 and charging circuit 55. The power reception side rectification circuit 54 rectifies the alternating current power supplied from the power reception side resonance circuit 51 to convert it to direct current power, and supplies the direct current power to the charging circuit 55. The power reception side rectification circuit 54 is, for example, an AC/DC converter.

The charging circuit 55 is electrically connected to the power reception side rectification circuit 54 and the battery 32. In particular, it is connected to the battery 32 through a relay 38. The charging circuit 55 converts a voltage level of the direct current power supplied from the power reception side rectification circuit 54 to the voltage level of the battery 32, and supplies the power to the battery 32. If the power transmitted from the power transmission apparatus 4 is supplied by the power reception apparatus 5 to the battery 32, the battery 32 is charged. The charging circuit 55 is, for example, a DC/DC converter.

The ECU 34 performs various control operations of the vehicle 3. For example, the ECU 34 is electrically connected to the charging circuit 55 of the power reception apparatus 5, and controls the charging circuit 55 so as to control the charging of the battery 32 by the power transmitted from the power transmission apparatus 4. Further, the ECU 34 is electrically connected to the PCU 33, and controls the PCU 33 so as to control the transfer of power between the battery 32 and the motor 31. Furthermore, the ECU 34 controls a vehicle side first communication device 71 and vehicle side second communication device 72, which will be explained later.

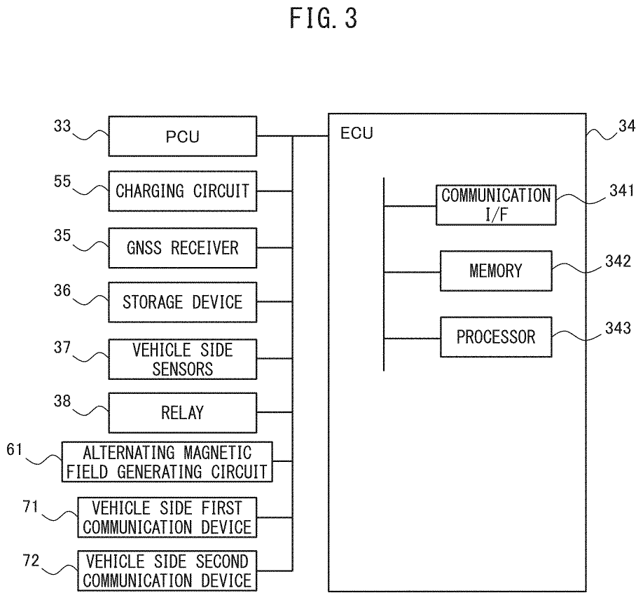

FIG. 3 is a schematic view of the configuration of the ECU 34 and equipment connected to the ECU 34. The ECU 34 has a communication interface 341, memory 342, and processor 343. The communication interface 341, memory 342, and processor 343 are connected to each other through signal wires.

The communication interface 341 has an interface circuit for connecting the ECU 34 to an internal vehicle network based on the CAN (Controller Area Network) or other standard. The ECU 34 communicates with other equipment through the communication interface 341.

The memory 342, for example, has a volatile semiconductor memory (for example, RAM) and nonvolatile semiconductor memory (for example, ROM). The memory 342 stores, for example, a computer program for performing various processing at the processor 343, and various data used when various processing is performed by the processor 343.

The processor 343 has one or more CPUs (central processing units) and their peripheral circuits. The processor 343 may further have a logic unit or arithmetic unit or other such processing circuit. The processor 343 performs various processing based on the computer program stored in the memory 342.

Further, as shown in FIG. 3, the vehicle 3 is further provided with a GNSS receiver 35, storage device 36, plurality of vehicle side sensors 37, relay 38, and HMI device 39. The GNSS receiver 35, storage device 36, vehicle side sensors 37, relay 38, and HMI device 39 are electrically connected to the ECU 34 through the internal vehicle network.

The GNSS receiver 35 detects the current position of the vehicle 3 (for example, the latitude and longitude of the vehicle 3), based on the positioning information of a plurality (for example, three or more) positioning satellites. Specifically, the GNSS receiver 35 captures a plurality of positioning satellites, and receives signals emitted from the positioning satellites. Further, the GNSS receiver 35 calculates the distances to the positioning satellites based on the times of emission and times of reception of the signals, and detects the current position of the vehicle 3 based on the distances to the positioning satellites and the positions of the positioning satellites (orbital information). The output of the GNSS receiver 35, that is, the current position of the vehicle 3 detected by the GNSS receiver 35, is transmitted to the ECU 34. The GNSS receiver 35 may include, for example, a GPS receiver.

The storage device 36 stores data. The storage device 36 is, for example, provided with a hard disk drive (HDD), solid state drive (SSD), or optical recording medium. In the present embodiment, the storage device 36 stores map information. The map information includes, in addition to information relating to the roads, the installation position information of the ground power supplying apparatuses 2 and other information. The ECU 34 acquires the map information from the storage device 36. Note that, the storage device 36 need not include the map information. In this case, the ECU 34 may acquire the map information from the outside of the vehicle 3 (for example, the later explained the server 91) through the vehicle side first communication device 71.

The vehicle side sensors 37 detect the states of the vehicle 3. In the present embodiment, the vehicle side sensors 37 include, as sensors for detecting the states of the vehicle 3, a speed sensor for detecting the speed of the vehicle 3, a battery temperature sensor for detecting the temperature of the battery 32, a power reception apparatus temperature sensor for detecting the temperature of various equipment of the power reception apparatus 5 (in particular, the power reception side resonance circuit 51 and power reception side rectification circuit 54), a battery current sensor for detecting the value of the charge current and value of the discharge current of the battery 32, a power reception apparatus current sensor for detecting the current flowing to various equipment of the power reception apparatus 5, and a power reception apparatus voltage sensor for detecting voltage applied to various equipment of the power reception apparatus 5. The outputs of the vehicle side sensors 37 are input to the ECU 34.

The relay 38 is arranged between the battery 32 and power reception apparatus 5, and connects and disconnects the battery 32 and power reception apparatus 5. When the relay 38 is connected, the power received by the power reception apparatus 5 is supplied to the battery 32. However, when the relay 38 is disconnected, current does not flow from the power reception apparatus 5 to the battery 32, and accordingly the power reception apparatus 5 can no longer substantially receive power.

The HMI device 39 is an interface for transfer of information with a vehicle occupant. The HMI device 39 according to the present embodiment is provided with a display and speaker for supplying the vehicle occupant with various information and a touch panel (or operating buttons) for the vehicle occupant to operate to input information. The HMI device 39 transmits the input information which was input by the vehicle occupant to various equipment (for example the ECU 34) which require that input information through the internal vehicle network and displays information received through the internal vehicle network on a display to the vehicle occupant.

Note that, the power reception apparatus 5 may also be configured to be able to transmit power to the ground power supplying apparatus 2. In this case, the power reception apparatus 5, like the power transmission apparatus 4 of the ground power supplying apparatus 2, is configured to transmit power of the battery 32 to the ground power supplying apparatus 2. Further, in this case, the power reception apparatus 5 may utilize a resonator comprised of the above-mentioned coil 52 and capacitor 53 for transmitting power to the ground power supplying apparatus 2.

Configuration of Communication System

In the noncontact power supplying system 1 such as shown in FIG. 1, in order to transfer power by noncontact from the ground power supplying apparatus 2 to the vehicle 3, the ground power supplying apparatus 2 has to identify the vehicle 3 running over the power transmission apparatus 4, and needs the demanded supplied power and other information of the vehicle 3.

Therefore, in the present embodiment, when the vehicle 3 is far away from the installation position of the ground power supplying apparatus 2 by a certain extent, the vehicle 3 transmits vehicle information tied to the vehicle identification information by wide area wireless communication from the vehicle 3 to the ground power supplying apparatus. Further, when the vehicle 3 approaches the installation position of the ground power supplying apparatus 2 or the vehicle 3 reaches the power transmission apparatus 4 of the ground power supplying apparatus 2, the vehicle 3 transmits the vehicle identification information by short range wireless communication from the vehicle 3 to the ground power supplying apparatus 2. That is, in the present embodiment, the vehicle information is transmitted by wide area wireless communication from the vehicle 3 to the ground power supplying apparatus 2 in advance, then the vehicle identification information is transmitted by short range wireless communication from the vehicle 3 to the ground power supplying apparatus 2.

In this regard, the vehicle identification information is information for identifying the vehicle 3, for example, is the vehicle ID. This vehicle identification information is stored in the memory 342 of the ECU 34 of the vehicle 3 in advance.

Further, the vehicle information is information of the vehicle 3 relating to power transfer, and includes the vehicle identification information. The vehicle information includes, for example, power (or electrical energy) demanded to be received from the ground power supplying apparatus 2, that is, the vehicle demand power (or the vehicle demand electrical energy). The vehicle demand power is calculated in the ECU 34 of the vehicle 3. Further, the vehicle information may also include information relating to the states of the vehicle, such as the states of the power reception apparatus 5 (connection state between the battery 32 and power reception apparatus 5), the state of charge SOC of the battery 32, the temperature of the battery 32, and the allowable charged power Win. In this case, the state of charge SOC of the battery 32 is calculated at the ECU 34 based on the value of the charge current and the value of the discharge current of the battery 32 detected by a vehicle side sensor 37 (battery current sensor). Further, the temperature of the battery 32 is detected by a vehicle side sensor 37 (battery temperature sensor). Further, the allowable charged power Win shows the maximum value of the charged power for not causing precipitation of metal lithium on the negative electrode surface of a lithium ion battery. This allowable charged power Win is calculated at the ECU 34 based on the charging history of the battery 32, the state of charge SOC of the battery 32, and the temperature of the battery 32.

In addition, the vehicle information includes the current position information of the vehicle 3. The current position information of the vehicle 3 is calculated at the ECU 34, based on the output of the GNSS receiver 35. Furthermore, the vehicle information may also include information relating to the power reception apparatus 5, such as the various parameters of the coil 44 and capacitor 45 of the power reception apparatus 5 (the outside diameter and the inside diameter of the coil 44, the number of turns of the coil 44, the electrostatic capacity of the capacitor 45, etc.), the height of the coil 44 from the ground surface, and the resonance frequency of the power reception side resonance circuit 51. Such vehicle information is stored in advance in the memory 342 of the ECU 34 of the vehicle 3. Furthermore, the vehicle information may include the user information required when the utilization fee is charged, such as, for example, authentication information identifying the settlement account of the user. Such vehicle information, for example, is registered in advance by the user using the input device of the vehicle 3, or is registered in advance by insertion of a card having the authentication information in a card reading device provided at the vehicle 3.

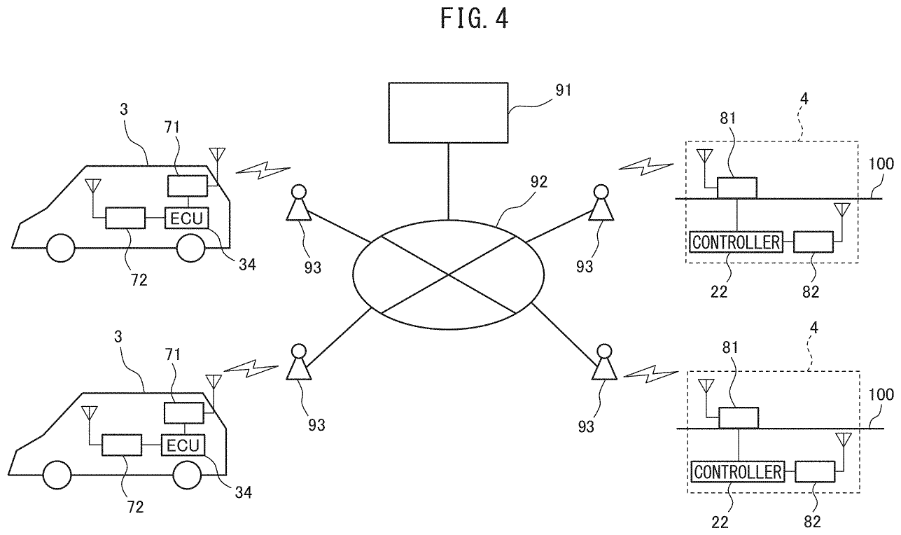

FIG. 4 is a schematic view of the configuration of a communication system used in the noncontact power supplying system 1. As shown in FIGS. 3 and 4, the vehicle 3 has a vehicle side first communication device 71 for performing wide area wireless communication and a vehicle side second communication device 72 for performing short range wireless communication. These vehicle side first communication device 71 and vehicle side second communication device 72 are connected to the ECU 34 through an internal vehicle network. On the other hand, as shown in FIGS. 2 and 4, the ground power supplying apparatus 2 has a ground side first communication device 81 for performing wide area wireless communication and a ground side second communication device 82 for performing short range wireless communication. These ground side first communication device 81 and ground side second communication device 82 are electrically connected to the controller 22 by cables. In particular, in the present embodiment, the vehicle side first communication device 71 and the ground side first communication device 81 utilize wide area wireless communication to directly or indirectly communicate in one direction or two directions. Further, the vehicle side second communication device 72 and the ground side second communication device 82 utilize short range wireless communication to directly communicate in one direction or two directions.

Wide area wireless communication is communication with a longer communication distance compared with short range wireless communication, specifically for example communication with a communication distance of 10 meters to 10 kilometers. As wide area wireless communication, various wireless communication schemes with long communication distances can be used. For example, the wide area wireless communication includes communication based on the 3GPP, the IEEE formulated 4G, LTE, 5G, WiMAX, or any other communication standard. As explained above, in the present embodiment, wide area wireless communication is utilized to transmit vehicle information tied with vehicle identification information from the vehicle 3 to the ground power supplying apparatus 2.

In the present embodiment, the vehicle side first communication device 71 of the vehicle 3 and the ground side first communication device 81 of the ground power supplying apparatus 2 communicate through the server 91. Specifically, the server 91 is connected to a plurality of wireless base stations 93 through a communication network 92 comprised of optical communication circuits. The vehicle side first communication device 71 and the ground side first communication device 81 communicate with the wireless base stations 93 using wide area wireless communication. Therefore, the vehicle side first communication device 71 of the vehicle 3 and the ground side first communication device 81 of the ground power supplying apparatus 2 communicate using wide area wireless communication.

Note that, the ground side first communication device 81 may also be connected to the communication network 92 by cable. Therefore, the ground side first communication device 81 may be connected to the server 91 not wirelessly, but by wire. Further, the vehicle side first communication device 71 may also wirelessly communicate with the ground side first communication device 81 directly or through the communication network without going through the server 91. Therefore, the server 91 communicates with the vehicle 3 by wide area wireless communication, and communicates with the ground power supplying apparatus 2 wirelessly or by cable.

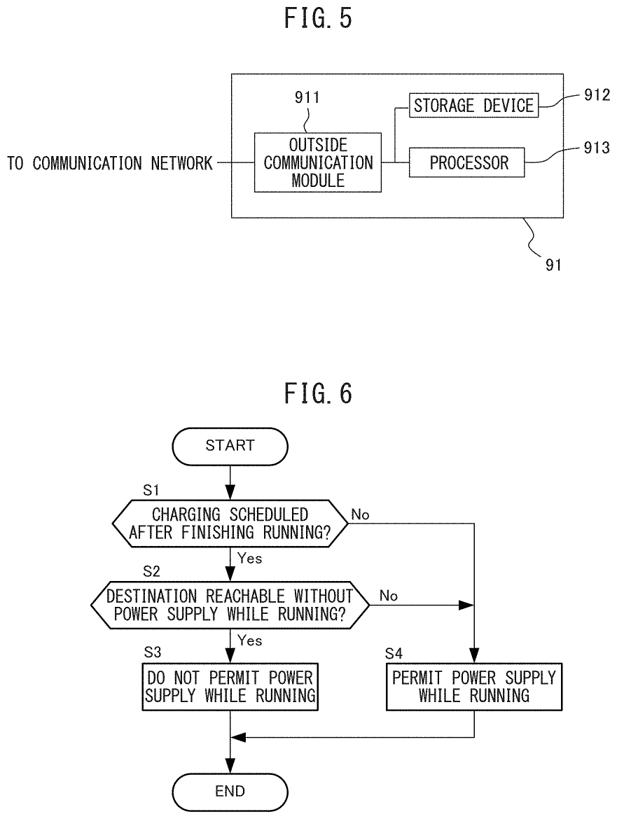

FIG. 5 is a view schematically showing the hardware configuration of the server 91. The server 91, as shown in FIG. 5, is provided with an external communication module 911, storage device 912, and processor 913. Further, the server 91 may have input devices such as a keyboard and mouse, and an output device such as a display.

The external communication module 911 communicates with equipment outside the server 91 (ground power supplying apparatuses 2, vehicles 3, etc.) The external communication module 911 is provided with an interface circuit for connecting the server 91 with the communication network 92. The external communication module 911 is configured to be able to communicate through the communication network 92 and wireless base stations 93 with each of a plurality of vehicles 3 and ground power supplying apparatuses 2.

The storage device 912 has a volatile semiconductor memory (for example, RAM), nonvolatile semiconductor memory (for example, ROM), hard disk drive (HDD), solid state drive (SSD), or optical recording medium. The storage device 912 stores a computer program for the processor 913 to perform various processing, and various data used when various processing is performed by the processor 913. Further, in the present embodiment, the storage device 912 stores map information. The map information includes, in addition to information relating to roads, information on the installation positions of ground power supplying apparatuses 2 and other information and information on the installation positions of charging stations, parking lots, and other stationary type power supplying facilities and other information.

The processor 913 has one or more CPUs and their peripheral circuits. The processor 913 may further have a GPU or logic unit or arithmetic unit or other such processing circuit. The processor 913 performs various processing based on the computer program stored in the storage device 912 of the server 91.

Short range wireless communication indicates communication with a shorter communication distance compared with wide area wireless communication, and specifically, for example, indicates communication with a communication distance of less than 10 meters. As short range wireless communication, various short range wireless communication schemes with short communication distances can be used. For example, the short range wireless communication includes communication based on any communication standard formulated by the IEEE, ISO, IEC, etc. (for example, Bluetooth® and ZigBee®). Further, as the art for performing short range wireless communication, for example, RFID (Radio Frequency Identification), DSRC (Dedicated Short Range Communication) can be used. As explained above, in the present embodiment, the vehicle identification information is transmitted from the vehicle 3 to the ground power supplying apparatus 2, by using short range wireless communication.

In the present embodiment, the vehicle side second communication device 72 of the vehicle 3 and the ground side second communication device 82 of the ground power supplying apparatus 2 directly communicate by short range wireless communication. In the present embodiment, the vehicle side second communication device 72 transmits a signal including vehicle identification information, and the ground side second communication device 82 receives the signal including vehicle identification information.

The vehicle side second communication device 72 has an antenna for generating an electric wave or magnetic field, and a transmission circuit for supplying the antenna with electric power or current. The transmission circuit has an oscillation circuit, modulation circuit, and amplification circuit. The transmission circuit modulates a carrier wave generated at the oscillation circuit by the modulation circuit, in accordance with the vehicle identification information, and supplies the alternating current (alternating current power) generated by amplifying the modulated carrier wave by the amplification circuit, to the antenna. As a result, at the antenna, an electric wave or magnetic field is generated.

The ground side second communication device 82 has an antenna for receiving an electric wave or magnetic field, and a reception circuit for retrieving information from the electric wave or magnetic field received by the antenna. The reception circuit has an amplification circuit and demodulation circuit. The reception circuit amplifies the weak current generated by the electric wave or magnetic field received by the antenna by the amplification circuit, and demodulates the amplified signal by the demodulation circuit to thereby retrieve the information which was included in the signal (here, the vehicle identification information).

Note that, the communication between the vehicle side second communication device 72 and the ground side second communication device 82 may be performed by an electric wave, or may be performed by a magnetic field (that is, electromagnetic induction). In particular, in the case where the frequency of the carrier wave is low (for example, 50 Hz to 50 kHz), communication is performed by a magnetic field. In this case, a coil can be used as the antenna.

Further, the present embodiment is configured so that the vehicle side second communication device 72 transmits a signal, and the ground side second communication device 82 receives the signal. However, the vehicle side second communication device 72 may also have a reception circuit so as to be able to not only transmit, but also receive a signal. Further, the ground side second communication device 82 may also have a transmission circuit so as to be able to not only receive, but also send a signal.

General Flow of Power Supply Next, the general flow of control when power is transferred by noncontact from the ground power supplying apparatus 2 to the vehicle 3 in the noncontact power supplying system 1 of the present embodiment, will be explained.

When power is transferred by noncontact from the ground power supplying apparatus 2 to the vehicle 3, first, the ECU 34 of the vehicle 3 makes the vehicle side first communication device 71 transmit vehicle information tied to the vehicle identification information to the ground side first communication device 81 of the ground power supplying apparatus 2. If the vehicle side first communication device 71 transmits vehicle information tied to the vehicle identification information, the ground side first communication device 81 of the ground power supplying apparatus 2 receives that vehicle information through wide area wireless communication. In particular, in the present embodiment, the ground side first communication device 81 of the ground power supplying apparatus 2 receives vehicle information of the vehicle 3 positioned within a predetermined nearby region in the surroundings of the ground power supplying apparatus 2.

As explained above, the memory 222 of the controller 22 of the ground power supplying apparatus 2 stores an identification information list of vehicle identification information of vehicles 3 which can be supplied with power by the ground power supplying apparatus. If the ground side first communication device 81 receives vehicle information tied with vehicle identification information from a vehicle 3, the controller 22 of the ground power supplying apparatus 2 registers the vehicle information tied with vehicle identification information in the identification information list. In particular, in the present embodiment, the ground side first communication device 81 receives vehicle information of a vehicle 3 positioned in the nearby region, therefore the vehicle identification information of the vehicle 3 positioned within the nearby region is registered in the identification information list.

If vehicle identification information of even one vehicle 3 is registered at the identification information list, the controller 22 of the ground power supplying apparatus 2 actuates the ground side second communication device 82 so that it is possible to communicate with the vehicle side second communication device 72, that is, it is possible to receive vehicle identification information from the vehicle side second communication device 72, and renders the ground power supplying apparatus 2 the communication standby state. If in this way the ground side second communication device 82 is rendered the communication standby state, if the vehicle 3 emitting the signal including the vehicle identification information from the vehicle side second communication device 72 approaches it, the ground side second communication device 82 can receive the signal including the vehicle identification information emitted by the vehicle side second communication device 72.

Further, when the vehicle identification information is registered in the identification information list, the controller 22 of the ground power supplying apparatus 2 makes the ground side first communication device 81 send a notification of the vehicle identification information being registered in the identification information list, to the vehicle 3 identified by this vehicle identification information. Note that, if as explained above, the vehicle identification information is registered in the identification information list, the ground side second communication device 82 is actuated. Therefore, the notification of vehicle identification information being registered in the identification information list can be said to be a notification showing that the ground side second communication device 82 will be actuated or is being actuated so as to enable the ground power supplying apparatus 2 to receive the vehicle identification information by using short range wireless communication.

If the vehicle side first communication device 71 receives a notification that the vehicle identification information has been registered in the identification information list from the ground side first communication device 81 through wide area wireless communication, the ECU 34 of the vehicle 3 supplies power to the vehicle side second communication device 72 to actuate it so that when the vehicle 3 approaches the ground power supplying apparatus 2, it can emit a signal including the vehicle identification information to the ground side second communication device 82 of the ground power supplying apparatus 2 and in addition supplies power to the power reception apparatus 5 to actuate it so that when the vehicle 3 runs over the ground power supplying apparatus 2, it can receive power from the ground power supplying apparatus 2. Due to this, the vehicle 3 is rendered a power reception active/signal emission state.

If the vehicle 3 approaches the ground power supplying apparatus 2 in a state where the vehicle side second communication device 72 is actuated and emits a signal including vehicle identification information and the ground side second communication device 82 is actuated so as to be able to communicate with the vehicle side second communication device 72, the ground side second communication device 82 receives the signal including vehicle identification information emitted from the vehicle side second communication device 72 of the vehicle 3.

If the ground side second communication device 82 receives vehicle identification information, the controller 22 of the ground power supplying apparatus 2 compares the received vehicle identification information against the identification information list. Further, when the received vehicle identification information is registered at the identification information list, power is supplied to the power transmission side resonance circuit 43 and the ground power supplying apparatus 2 is rendered a power transmission active state so that it is possible to transmit power to the vehicle 3 when the vehicle 3 is running over the ground power supplying apparatus 2. If the vehicle 3 moves in this way in a state where the power transmission side resonance circuit 43 of the ground power supplying apparatus 2 is supplied with power and in a state where the power reception apparatus 5 of the vehicle 3 is actuated, when the power reception side resonance circuit 51 of the vehicle 3 is positioned over the power transmission side resonance circuit 43 of the ground power supplying apparatus 2, power is supplied from the ground power supplying apparatus 2 to the vehicle 3. If, after that, the vehicle 3 moves and the power reception apparatus 5 of the vehicle 3 moves away from the power transmission apparatus 4 of the ground power supplying apparatus 2, the supply of power is ended.

Permission for Power Supply while Running

Here, comparing a case of supplying power to a running vehicle 3 by noncontact and a case of supplying power by contact by a cable or supplying power by noncontact wirelessly to the vehicle 3 in the state parked and stopped after finishing running, the power loss tends to become greater in the former case. For this reason, if comparing the electricity bill in the case of receiving power by noncontact power supply while running and the electricity bill in the case of receiving power by contact power supply or noncontact power supply while parked and stopped, even with the same amount of received power, the electricity bill is liable to become more higher in the former case.

Further, if it is possible to supply power by contact or supply power by noncontact to a vehicle 3 in the state parked and stopped after finishing running, sometimes power does not have to be received by noncontact power supply while running where the power loss would become greater. However, at the present time, it is not possible to judge whether to receive power by noncontact power supply while running based on such a viewpoint, so power is liable to end up being supplied by noncontact while running where the power loss would become greater regardless of power being able to be supplied by contact or power being able to be supplied by noncontact to a vehicle 3 in a state parked and stopped after finishing running.

Therefore, in the present embodiment, it is made possible to judge whether to receive power by noncontact power supply while running based on charging scheduled after the vehicle 3 finishes running.

FIG. 6 is a flow chart for explaining one example of processing performed at the ECU 34 of the vehicle 3, in particular processing for judging whether to receive power by noncontact power supply based on charging scheduled after the vehicle 3 finishes running. The ECU 34 repeatedly performs the present routine at predetermined intervals while the vehicle 3 is running.

At step S1, the ECU 34 judges whether there is charging scheduled after finishing running. If there is charging scheduled after finishing running, the ECU 34 performs the processing of step S2. On the other hand, if there is no charging scheduled after finishing running, it proceeds to the processing of step S4.

Note that, if the vehicle occupant inputs a driving schedule or charging scheduled of the vehicle 3 through the HMI device 39, whether there is charging scheduled after finishing running can be judged based on that driving schedule or charging scheduled. For example, if the driving schedule is input, by communicating with the server 91, it is possible to obtain a grasp of the destination and the parked time at the destination from the driving schedule and possible to obtain a grasp of infrastructure information of the destination (existence of any cable or wireless stationary type power supplying facility) and to judge the existence of charging scheduled based on the infrastructure information of the destination and parked time at the destination. Specifically, if there is a stationary type power supplying facility present at the destination and the parked time at the destination is greater than or equal to a predetermined time, there is a high possibility of being charged using the stationary type power supplying facility at the destination, so it is possible to judge that there is charging scheduled. Further, if charging scheduled has been input, it is possible to directly judge from that charging scheduled if there is charging scheduled after finishing running.

Further, even if the vehicle occupant does not input the driving schedule or charging scheduled of the vehicle 3, it is possible to judge whether charging is scheduled after finishing running based on information on the past charging history of the vehicle 3 (for example, information relating to the running route and running time of day before parking and stopping or information on the location and time of day at which charging was performed in the parked and stopped state etc.)

At step S2, the ECU 34 judges whether the destination can be reached without noncontact power supply while running. In the present embodiment, if the distance to the destination is less than a predetermined judgment threshold value, the ECU 34 judges that the destination can be reached without noncontact power supply while running and proceeds to the processing of step S3. On the other hand, if the distance to the destination is over the judgment threshold value, the ECU 34 judges that without noncontact power supply while running, the destination is liable to not be reached and proceeds to the processing of step S4.

Note that the judgment threshold value can, for example, be set based on a possible driving distance of the vehicle 3. Specifically, the judgment threshold value can be set to a larger value the longer the possible driving distance of the vehicle 3, that is, the higher the state of charge SOC of the battery 32. Note that, for example, it is possible to set the judgment threshold value to the possible driving distance itself of the vehicle 3.

Further, the judgment threshold value may be set considering the operating status of the air-conditioner or outside air temperature. For example, when the air-conditioner is operating, the state of charge SOC of the battery 32 is easily reduced more rapidly, so the judgment threshold value may be made smaller than when the air-conditioner is not operating. Further, when the outside air temperature is within a temperature range where the possibility of air-conditioner operation is high, the judgment threshold value may be made smaller than when it is outside that temperature range.

Further, the judgment threshold value may be set considering the vehicle type such as whether the vehicle 3 is an electric vehicle or a hybrid vehicle. For example, if the vehicle 3 is an electric vehicle, it cannot run if the power runs out, so the judgment threshold value may be made smaller than if the vehicle 3 is a hybrid vehicle.

Further, if the vehicle occupant inputs a driving schedule of the vehicle 3 through the HMI device 39, where the destination is can be judged based on that driving schedule. Further, if a driving schedule is not input, it can be judged based on the information of the past running and charging history of the vehicle 3.

At step S3, the ECU 34 does not permit noncontact power supply while running. In the present embodiment, when, in the present step, noncontact power supply while running is not permitted, for example, transmission of vehicle information by the vehicle side first communication device 71 and transmission of a signal including vehicle identification information by the vehicle side second communication device 72 are stopped so that the ground power supplying apparatus 2 is not rendered the above-mentioned power transmission active state.

At step S4, the ECU 34 permits noncontact power supply while running.

Modification

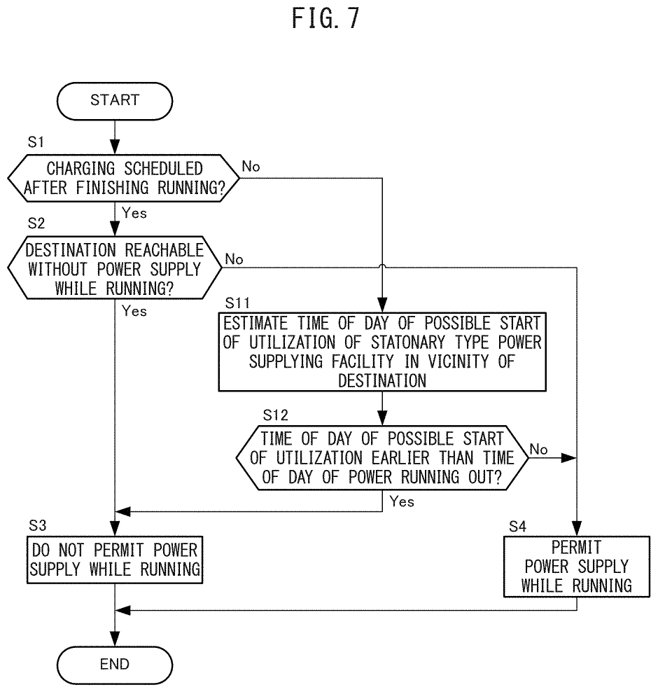

Note that, in the flow chart of FIG. 6, if there is no charging scheduled after finishing running, noncontact power supply while running is permitted, but, for example, like in the flow chart shown in FIG. 7, it is also possible to estimate the time of day at which the vehicle 3 (host vehicle) can start to be charged utilizing a stationary type power supplying facility (that is, the time of day of possible start of utilization of a stationary type power supplying facility) based on the operating statuses of stationary type power supplying facilities in the vicinity of the destination and the charged states of other vehicles in the middle of utilizing stationary type power supplying facilities (step S11) and to not permit the reception of power from a ground power supplying apparatus while running even when there is no charging scheduled after finishing running if the time of day of possible start of utilization of that stationary type power supplying facility is earlier than the projected time of day of power of the vehicle 3 running out (step S12). Due to this, if possible for the vehicle 3 to reach its destination without being liable to run out of power and there is a high possibility of being able to be charged at the destination utilizing a stationary type power supplying facility, it is possible to keep power from ending up being received by noncontact power supply while running.

Note that, the operating status of the stationary type power supplying facilities in the vicinity of the destination and the charged states of other vehicles in the middle of utilizing the stationary type power supplying facilities, for example, can be acquired by communicating with the server in which this information is concentrated (may be server 91 or may be another server). Further, the projected time of day of power of the vehicle 3 running out, for example, can be made the time of day at which power would be expected to run out if the vehicle 3 were to maintain its current running state.

Further, if the time of day of possible start of utilization of the stationary type power supplying facility is earlier than the projected time of day of power of the vehicle 3 running out, whether to not permit reception of power from the ground power supplying apparatus while running may be made to be selected by the preference of the occupant of the vehicle 3.

Further, in the flow chart of FIG. 6, the judgment of step S2 was made after step S1, but it is also possible to not perform the judgment of step S2 but to proceed to the processing of step S3. That is, if there is charging scheduled after the vehicle 3 finishes running, it is also possible to not permit the reception of power from the ground power supplying apparatus 2 while running.

### Action and Effect

According to the present embodiment explained above, the vehicle 3 configured to receive power from the ground power supplying apparatus by noncontact is provided with the ECU 34 (control device) provided with the processor 343 configured to control the reception of power from the ground power supplying apparatus 2 while running based on charging scheduled after the vehicle 3 finishes running.

Due to this, according to the present embodiment, it is possible to suitably judge whether to supply power by noncontact while the vehicle 3 is running considering the charging scheduled after finishing running, so it is possible to keep from ending up receiving power by noncontact power supply while running, where the power loss would become larger, regardless of power being able to be supplied by contact or power being able to be supplied by noncontact to a vehicle in a state parked and stopped after finishing running.

Note that, charging scheduled after the vehicle 3 finishes running can be grasped based on information regarding charging scheduled or the driving schedule of the vehicle 3 provided from an occupant of the vehicle 3 or information on a past charging history of the vehicle 3.

Further, the processor 343 of the ECU 34 according to the present embodiment is configured so as to control the reception of power from the ground power supplying apparatus 2 while running based on charging scheduled after the vehicle 3 finishes running and further the result of comparison of the distance of the vehicle 3 to the destination and the predetermined judgment threshold value. Specifically, the processor 343 of the ECU 34 is configured to set the judgment threshold value based on the possible driving distance of the vehicle 3 or the state of charge SOC of the battery 32 mounted in the vehicle 3 and to not permit the reception of power from the ground power supplying apparatus 2 while running if there is charging scheduled after the vehicle 3 finishes running and the distance of the vehicle 3 to the destination is less than the judgment threshold value.

Due to this, it is possible to not permit the reception of power from the ground power supplying apparatus 2 while running when there is charging scheduled after finishing running and the distance of the vehicle 3 to the destination is less than the judgment threshold value and it is expected that the destination can be reached without noncontact power supply while running. For this reason, it is possible to keep from ending up supplying power by noncontact while running regardless of power being able to be supplied by contact or power being able to be supplied by noncontact to a vehicle in a state parked after finishing running.

Note that, the judgment threshold value may be set considering the operating status of the air-conditioner mounted in the vehicle 3 or the outside air temperature and may be set considering the type of the vehicle 3. If setting it considering the type of the vehicle 3, the value is made smaller when the vehicle 3 is a vehicle (for example, BEV) not having an energy source other than the battery than when it is a vehicle (for example, HEV or PHEV) having an energy source other than the battery.

Due to this, it is possible to precisely project whether it would be possible to reach the destination without noncontact power supply while running.

Further, the processor 343 of the ECU 34 according to the present embodiment is configured to obtain a grasp of infrastructure information and a parked time at the destination of the vehicle 3 based on information provided from the occupant of the vehicle 3, in particular information relating to scheduled running of the vehicle 3, and not permit the reception of power from the ground power supplying apparatus 2 while running if there is a stationary type power supplying facility at the destination and the parked time at that destination is greater than or equal to the predetermined time.

Due to this, even if there is no direct information relating to charging scheduled, it is possible to judge the probability of charging performed using a stationary type power supplying facility at the destination from information relating to scheduled running so as to suitably judge whether to supply power by noncontact while running.

Further, the processor 343 of the ECU 34 according to a modification of the present embodiment is configured so that, even if there is no charging scheduled after the vehicle 3 finishes running, it does not permit the reception of power from the ground power supplying apparatus 2 while running when the time of day of possible start of utilization of the stationary power supplying facility in the vicinity of the destination estimated based on the operating status of that stationary power supplying facility and the states of charging of other vehicles in the middle of utilizing that stationary power supplying facility is earlier than a projected time of day of power of the vehicle 3 running out.

Due to this, if there is a high possibility of it being possible for the vehicle 3 to reach its destination without being liable to run out of power and of it being able to be charged at the destination utilizing the stationary type power supplying facility, it is possible to keep power from ending up being received by noncontact power supply while running.

Above, an embodiment of the present disclosure was explained, but the above embodiment only shows some of the applications of the present disclosure and is not meant to limit the technical scope of the present disclosure to the specific constitution of the above embodiment.

For example, in the above-mentioned embodiment, the ECU 34 mounted in the vehicle as a control device was used for the processing shown in FIG. 6 and FIG. 7, that is, the processing for judging whether to receive power by noncontact power supply while running based on charging scheduled after the vehicle 3 finishes running, but the control device is not limited to the ECU 34. For example, it may also be a smartphone or other terminal configured to be able to communicate with the vehicle and linked with the vehicle.

Further, the above embodiment, if changing the viewpoint, may also be interpreted as a method of control of power reception of the vehicle 3 receiving power from the ground power supplying apparatus 2 by noncontact comprising controlling the reception of power from the ground power supplying apparatus 2 while running based on charging scheduled after the vehicle 3 finishes running.

Further, the above embodiment may also be interpreted as a program for making the processor 343 of the control device of the ECU 34 (control device) of the vehicle 3 receiving power from the ground power supplying apparatus 2 by noncontact control the reception of power from the ground power supplying apparatus 2 while running based on charging scheduled after the vehicle 3 finishes running or a nontransitory computer recording medium including that program.

1. A vehicle configured to receive power from a ground power supplying apparatus by noncontact, wherein
the vehicle comprises a control device provided with a processor configured to control reception of power from the ground power supplying apparatus while running based on charging scheduled after the vehicle finishes running.

2. The vehicle according to claim 1, wherein
the processor is configured to obtain a grasp of charging scheduled based on information provided from an occupant of the vehicle or information on a past charging history of the vehicle.

3. The vehicle according to claim 2, wherein
the information provided from the occupant of the vehicle is information relating to charging scheduled of the vehicle.

4. The vehicle according to claim 2, wherein
the information provided from the occupant of the vehicle is information relating to a driving schedule of the vehicle.

5. The vehicle according to claim 4, wherein
the processor is configured:
to obtain a grasp of infrastructure information and parked time at the destination of the vehicle based on information provided from the occupant of the vehicle; and
not to permit the reception of power from the ground power supplying apparatus while running if there is a stationary power supplying facility at the destination and the parked time at that destination is greater than or equal to a predetermined time.

6. The vehicle according to claim 1, wherein
the processor is configured not to permit the reception of power from the ground power supplying apparatus while running if there is charging scheduled after the vehicle finishes running.

7. The vehicle according to claim 1, wherein
the processor is configured to control the reception of power from the ground power supplying apparatus while running based on charging scheduled after the vehicle finishes running and a result of comparison of a distance of the vehicle to the destination and a predetermined judgment threshold value.

8. The vehicle according to claim 7, wherein
the processor is configured:
set the judgment threshold value based on a possible driving distance of the vehicle or a state of charge of a battery mounted in the vehicle; and
not to permit the reception of power from the ground power supplying apparatus while running if there is charging scheduled after the vehicle finishes running and the distance of the vehicle to the destination is less than the judgment threshold value.

9. The vehicle according to claim 8, wherein
the judgment threshold value is set further considering the operating state of an air-conditioner mounted in the vehicle or an outside air temperature.

10. The vehicle according to claim 8, wherein
the judgment threshold value is set further considering a vehicle type of the vehicle.

11. The vehicle according to claim 10, wherein
the judgment threshold value is made smaller in the case where the vehicle is a vehicle not having an energy source other than a battery than the case where it is a vehicle having an energy source other than a battery.

12. The vehicle according to claim 1, wherein
the processor is configured:
not to permit the reception of power from the ground power supplying apparatus while running if there is charging scheduled after the vehicle finishes running; and,
even if there is no charging scheduled after the vehicle finishes running, not to permit the reception of power from the ground power supplying apparatus while running when a time of day of possible start of utilization of a stationary power supplying facility in the vicinity of a destination estimated based on a state of operation of that stationary power supplying facility and a state of charging of another vehicle in the middle of utilizing that stationary power supplying facility is earlier than a projected time of day of power of the vehicle running out.

13. A method of control of reception of power of a vehicle configured to receive power from a ground power supplying apparatus by noncontact,
the method of control of reception of power of a vehicle comprising controlling the reception of power from the ground power supplying apparatus while running based on charging scheduled after the vehicle finishes running.

14. A nontransitory computer recording medium including a program for making a processor of a control device of a vehicle receiving power from a ground power supplying apparatus by noncontact control the reception of power from the ground power supplying apparatus while running based on charging scheduled after the vehicle finishes running.
